(19) United States
(12) Patent Application Publication
(10) Pub. No.: US 2022/0378013 A1
(43) Pub. Date: Dec. 1, 2022

(54) APPARATUS AND METHOD FOR INTEGRATED PET ENCLOSURE

(71) Applicant: Jennifer Nguyen, Portland, OR (US)

(72) Inventor: Jennifer Nguyen, Portland, OR (US)

(21) Appl. No.: 17/731,564

(22) Filed: Apr. 28, 2022

Related U.S. Application Data
(60) Provisional application No. 63/194,380, filed on May 28, 2021.

(51) Int. Cl. A01K 1/035; A01K 1/01; A01K 1/03

(52) U.S. Cl. CPC A01K 1/0356; A01K 1/01; A01K 1/033

(57) ABSTRACT

A system and method for an integrated pet enclosure system for a pet is provided. One embodiment of the integrated pet enclosure system provides an integrated food storage and a supply storage region. The integrated pet enclosure system has a cabinet top, a cabinet bottom, a first cabinet end piece, a second cabinet end piece, and a back panel that all cooperatively define the integrated pet enclosure system. The integrated pet enclosure system comprises an entrance interior region; a litter box interior region; and a divider between the entrance interior region and the litter box interior region. The divider includes a hole to permit passage of a pet between the entrance interior region and the litter box interior region.

### PRIORITY CLAIM

This application claims priority to copending U.S. Provisional application, Ser. No. 63/194,380, filed on May 28, 2021, entitled Systems and Methods For Integrated Pet Enclosure, which is hereby incorporated by reference in its entirety for all purposes.

### BACKGROUND OF THE INVENTION

Some types of indoor pets, such as rabbits, are trained to use a litter box when relieving themselves of waste. Often, the pet's litter box is kept in a convenient location, such as a room, closet or the like. Further, food for the pet may be left out so that the pet is able to eat (free feed) throughout the day.

In some situations, the pet is placed in an enclosure while the pet owner is away from their home. Often, the pet's litter box and/or food is placed in the enclosure (interchangeably referred to herein as a hutch). However, such enclosures may be difficult to clean, access to replace litter and/or food, and my not be particularly pleasing to look at.

Accordingly, in the arts of pet keeping, there is a need to provide an improved pet enclosure.

### SUMMARY OF THE INVENTION

Embodiments of the integrated pet enclosure system provide a system and method provides an integrated food storage region and a supply storage region, wherein the integrated pet enclosure system has a cabinet top, a cabinet bottom, a first cabinet end piece, a second cabinet end piece, and a back panel that all cooperatively define the integrated pet enclosure system. The integrated pet enclosure system comprises an entrance interior region; a litter box interior region; and a divider between the entrance interior region and the litter box interior region. The divider includes a hole to permit passage of a pet between the entrance interior region and the litter box interior region.

### BRIEF DESCRIPTION OF THE DRAWINGS

The components in the drawings are not necessarily to scale relative to each other. Like reference numerals designate corresponding parts throughout the several views.

FIG. 1 is a perspective front view of an embodiment of the integrated pet enclosure system.

FIG. 2 is an opposing perspective front view of an embodiment of the integrated pet enclosure system.

FIG. 3 is a perspective front view of an opened embodiment of the integrated pet enclosure system.

FIG. 4 is a perspective front view with a house rabbit entering an embodiment of the integrated pet enclosure system.

FIG. 5 is a front view with a house rabbit inside a first interior region of an embodiment of the integrated pet enclosure system.

FIG. 6 is a perspective front view with a house rabbit using a litterbox inside an embodiment of the integrated pet enclosure system.

FIG. 7 is an exploded view of an example embodiment of the integrated pet enclosure system.

FIGS. 8A-8C are perspective views of an alternative embodiment of the integrated pet enclosure system.

FIG. 9 is an illustration of an embodiment of the integrated pet enclosure system that is decorative so as to be suitable for use in a living room of the pet owner's home.

### DETAILED DESCRIPTION

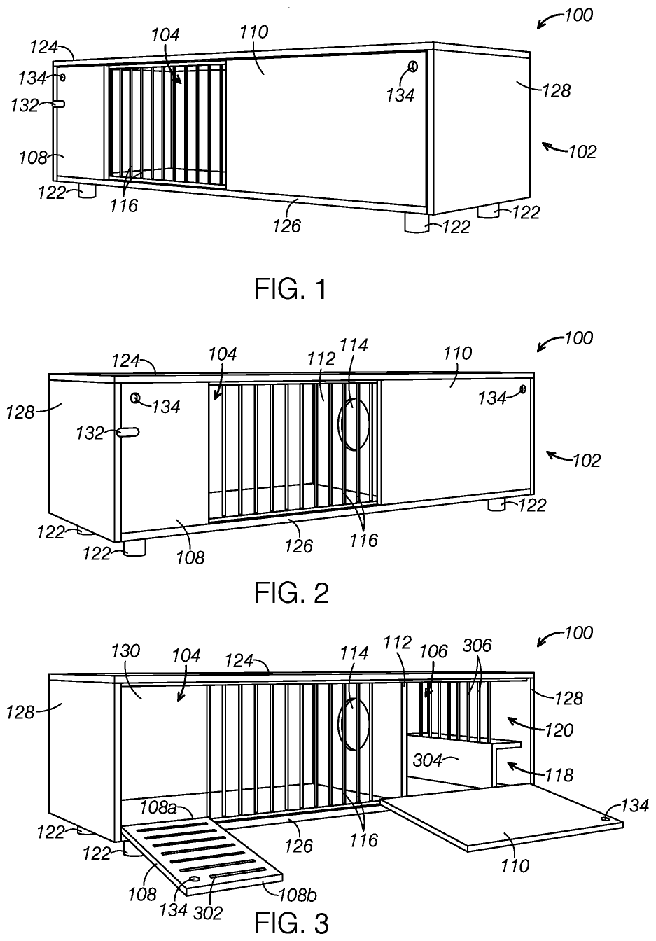

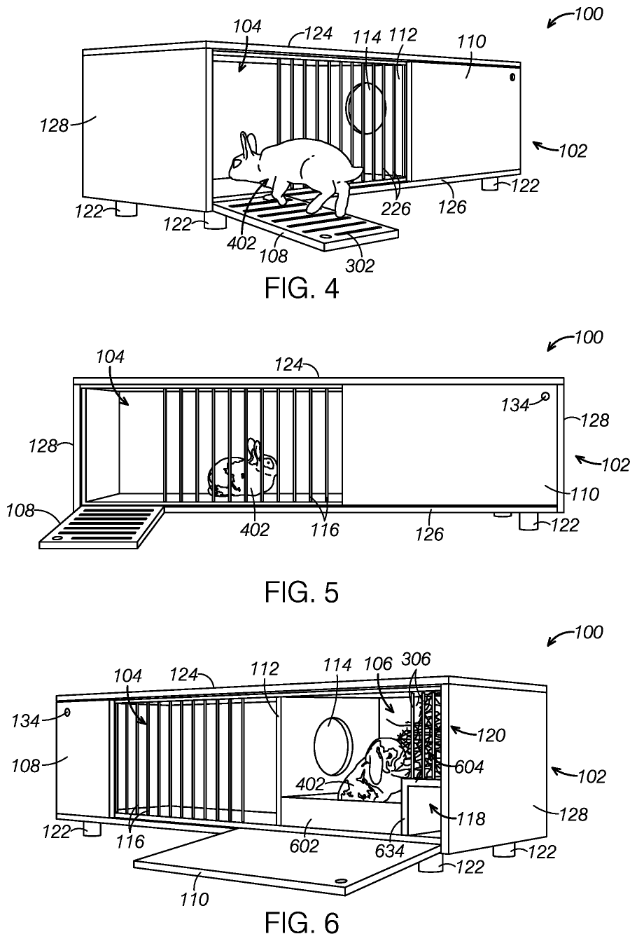

FIG. 1 is a perspective front view of an embodiment of the integrated pet enclosure system 100. FIG. 2 is an opposing perspective front view of an embodiment of the integrated pet enclosure system 100. FIG. 3 is a perspective front view of an opened embodiment of the integrated pet enclosure system 100. FIG. 4 is a perspective front view with a house rabbit entering an embodiment of the integrated pet enclosure system 100. FIG. 5 is a front view with a house rabbit inside a first interior region of an embodiment of the integrated pet enclosure system 100. FIG. 6 is a perspective front view with a house rabbit using a litterbox inside an embodiment of the integrated pet enclosure system 100.

Embodiments of the integrated pet enclosure system 100 provide a visually aesthetic indoor pet enclosure, and in particular, a visually aesthetic indoor pet rabbit enclosure. The integrated pet enclosure system 100 may be suitable for any pet that uses a litter box and, at the preference of the pet owner, needs to be secured in the enclosure while the pet owner is away, at night, or at other times of interest. One skilled in the art appreciates that the integrated pet enclosure system 100 may be used to house any type of house pet. Blankets, pillows, toys or the like may be placed within the entrance interior region 104.

The disclosed systems and methods for an integrated pet enclosure system 100 will become better understood through review of the following detailed description in conjunction with the figures. The detailed description and figures provide examples of the various inventions described herein. Those skilled in the art will understand that the disclosed examples may be varied, modified, and altered without departing from the scope of the inventions described herein. Many variations are contemplated for different applications and design considerations, however, for the sake of brevity, each and every contemplated variation is not individually described in the following detailed description.

Throughout the following detailed description, a variety of examples for systems and methods for an integrated pet enclosure system 100 are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components. “Secured to” means directly connected without intervening components.

Returning to FIGS. 1-6, the integrated pet enclosure system 100 is fabricated as a cabinet 102 that defines an entrance interior region 104 and a litter box interior region 106. The cabinet 102 comprises a ramp 108 or a sliding door 108, a litter box region cover 110, a divider 112 with a hole 114, a plurality of barrier dowels 116, a supply storage region 118 and a food storage region 120 within the litter box interior region 106, and a plurality of cabinet legs 122. The cabinet 102 structure includes a cabinet top 124, a cabinet bottom 126, and two cabinet end pieces 128, and a back panel 130.

In the example embodiment, the lower end (first edge 108a) of the ramp 108 is hinged-connected to the cabinet bottom 126. When the ramp 108 is oriented vertically, an opening into the integrated pet enclosure system is closed. When the ramp is oriented horizontally or is slanted downwardly, the pet owner can lower the ramp 108 so that the opposing upper end (second edge 108b) of the ramp 108 rests on the floor (see FIGS. 3-5) such that the pet 402 (FIGS. 4-6), here illustrated as a house rabbit, can enter into the entrance interior region 104. In some embodiments, the ramp 108 may be removeable for ease of access and to facilitate cleaning. The opposing second edge of the ramp rests upon a floor that is supporting the integrated pet enclosure system

Non-slip adhesive treads 302 (FIGS. 3 and 4) may be placed on the interior surface of the ramp 108 to prevent slippages and to assist entry of the pet 402 into the entrance interior region 104. Alternatively, or additionally, the inside surface of the ramp 108 may have corrugations or other structure fabricated into/onto the interior surface of the ramp 108.

In an alternative embodiment, the ramp 108 can be configured as a sliding door 108. Here, the bottom edge of the sliding door 108 is configured as a rail that slides along a corresponding track disposed along the outer edge of the cabinet bottom 126. A corresponding track may be optionally included in the cabinet top 124 that receives a rail at the top of the sliding door 108.

An optional divider 112 separates the entrance interior region 104 from the litter box interior region 106. The hole 114 permits the pet 402 to move freely between the entrance interior region 104 and the litter box interior region 106. An unexpected benefit provided by the divider 112 is to retain the litter from the litter box 602 (FIG. 6) and any food 604 (FIG. 6) in the food storage region 120 within the litter box interior region 106. In the illustrated embodiment, the hole 114 is circular. Any suitable shaped hole 114, such as a square, rectangle, oval or the like, may be used in alternative embodiments. Further, depending upon the particular needs of the pet, ramps (not shown) may be used to provide pet access through the hole 114. In some embodiments, an optional door or covering may be used cover the hole 114 to prevent the pet from moving through the hole 114.

In the example preferred embodiment, a barrier means, such as a plurality of barrier dowels 116, is set along and between the front edges of the cabinet top 124 and cabinet bottom 126. The barrier dowels 116 provide viewing of the pet 402 into an area proximate to the integrated pet enclosure system 100, and facilitate air circulation within the entrance interior region 104. When the ramp 108 is closed with the pet 402 inside the integrated pet enclosure system 100, the pet is restrained within the confines of the integrated pet enclosure system 100, yet is still able to view its outside environment through the barrier dowels 116. Any suitable material may be used for the barrier dowels 116, such as metal, powder coated metal, wood, plastic or the like. The barrier dowels 116 may have any suitable cross sectional shape.

In an example embodiment, the spacing and/or size of the barrier dowels 116 may be designed based upon the particular characteristics of the pet 402. Here, the spacing between the barrier dowels 116 is such that the pet 402 cannot squeeze between two adjacent barrier dowels 116 to make an escape from the integrated pet enclosure system 100. For example, the barrier dowels 116 may be more closely spaced together if the pet is a ferret (as contrasted to a relatively large house rabbit). In some embodiments, the barrier dowels 116 may be removeable for ease of access and to facilitate cleaning.

Any suitable structure can be used (rather than the barrier dowels 116). For example, a sheet of glass, acrylic, plexiglass or the like may be used instead of, or in conjunction with, the barrier dowels 116. Rungs (similar to horizontal oriented dowels) may be used and have any suitable cross sectional shape. In some embodiments, a wire screen, mesh, or the like may be used instead of, or in conjunction with, the barrier dowels 116. In some embodiments, a series of vertical and/or horizontal slits of a predefined width may be cut into a panel to emulate the series of barrier dowels 116. All such barrier means are intended to be within the scope of this disclosure and to be protected by the accompanying claims.

When the pet 104 is inside the integrated pet enclosure system 100, the ramp 108 may be closed (FIGS. 1 and 2) so that the pet 402 cannot leave the integrated pet enclosure system 100. A suitable securing means 132 may be used to secure the closed ramp 108 to the cabinet 102. Latches, barrel locks, roller catches, ball catches, deadlatches, cabinet latches, magnet catches, shutter bars, swivel hooks, pins, hasps, or the like may be used to secure the ramp 108. The securing means 132 may be selected so as to be aesthetic pleasing and to match with the décor of the room and design of the cabinet 102.

In the illustrated example embodiment, an inverted L-shaped member 304 (FIGS. 3 and 6) made of wood, metal, plastic, or the like is secured at the bottom corner inside the litter box interior region 106 to form the supply storage region 118. That is, the inverted L-shaped member 304 is connected to the cabinet bottom at a first end and is connected to the second cabinet end piece that defines in part the litter box interior region. the inverted L-shaped member 304 has a length corresponding to a length of a bottom edge of the second cabinet end piece 128. Here, the depth of the L-shaped member 304 is defined so that the remaining width of the litter box interior region 106 is sized to accommodate and retain the litter box 602 (FIG. 6). Accordingly, the inverted L-shaped member 304, a portion of the cabinet bottom 126, and a portion of the second cabinet end piece 128 define a storage space 118 within the litter box interior region that cannot be accessed by the pet.

Optionally, a plurality of vertically aligned food storage dowels 306 (FIGS. 3 and 6) disposed between the top surface of the inverted L-shaped member 304 and the bottom surface of the cabinet top 124 may be used to retain food in the food storage region 120 of the litter box interior region 106. Any suitable barrier means described herein may be used in alternative embodiments.

For example, if the pet 402 is a house rabbit, hay stored in the food storage region 120 can be retailed by the food storage dowels 306 while allowing access to the hay by the house rabbit. A water bottle (not shown) may be optionally suspended from the food storage dowels 306 and/or from the bottom surface of the cabinet top 124. For other types of pets 402, a short sheet of wood, metal, plastic or the like may be secured along the top outer edge of the L-shaped member 304. The sheet of material protrudes upwards so as to retain food bowls and/or water bowls within the food storage region 120. The height of the L-shaped member 304 may be defined so as to position the food storage region 120 at a level that is easily accessed by the pet 402 and/or to provide a suitable storage space for pet supplies.

In an example embodiment, the lower end of the litter box region cover 110 is hinged-connected to the cabinet bottom 126. The pet owner can lower the litter box region cover 110 so that the upper end of the litter box region cover 110 rests on the floor (see FIGS. 3 and 6) such that the owner can conveniently access the litter box interior region 106, the supply storage region 118, and/or the food storage region 120 for cleaning, for accessing pet supplies, and/or for replenishing food or water. In some embodiments, the litter box region cover 110 may be removeable for ease of access and to facilitate cleaning.

In an alternative embodiment, the litter box region cover 110 can be configured as a sliding door. Here, the bottom edge of the litter box region cover 110 is configured as a rail that slides along a corresponding track disposed along the outer edge of the cabinet bottom 126. A corresponding track may be optionally included in the cabinet top 124 that receives a rail at the top of the litter box region cover 110.

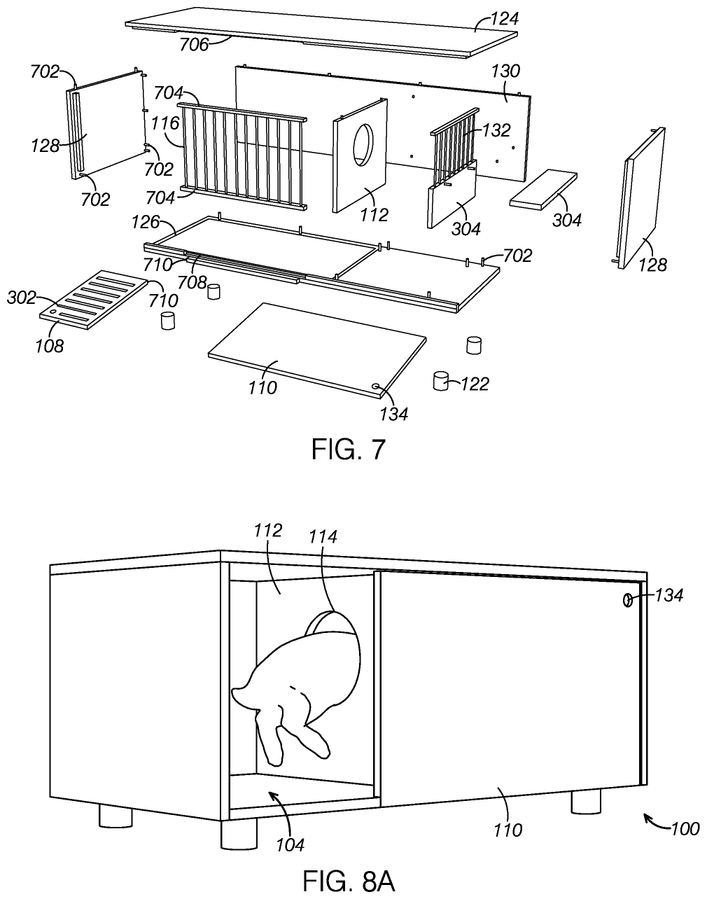

FIG. 7 is an exploded view of an example embodiment of the integrated pet enclosure system 100. Previously described elements are identified using the same reference numerals, and are not described again for brevity.

One skilled in the art appreciates that an unassembled integrated pet enclosure system 100 can be conveniently packaged and shipped to a purchasing pet owner. The pet owner may then conveniently assemble the integrated pet enclosure system 100.

In an example embodiment, a plurality of connector dowels 702 may be used to secure various elements to each other. Alternatively, screws, nails, slip joints adhesive or other fastening means may be used.

Optionally, some elements may be provided that are secured together prior to shipment to the purchasing pet owner. For example, but not limited to, the barrier dowels 116 may be arranged as secured between two frame pieces 704. The upper frame piece 704 may then be fit into a recess 706 cut into the cabinet top 124. The lower frame piece 704 may then be fit into a recess 708 in the cabinet bottom 126. The location of the recesses 706, 708 may be predefined so that the ramp 108 and the litter box region cover 110 can be secured in their proper locations on either end of the barrier dowels 116.

In an alternative embodiment, the recesses 706, 708 are configured to slidably receive the ramp 108 using a sliding means 710. The litter box region cover 110 may be similarly configured to slidably open via the recesses 706, 708. In such embodiments, the pet owner may slide the ramp 108 sideways into and along the recesses 706, 708. Here, the pet 402 would not have access to the ramp 108 to avoid the grasp of the pet owner. Similarly, the pet owner may slide the litter box region cover 110 sideways into and along the recesses 706, 708 to access the litter box region cover 110, supply storage region 118, and/or food storage region 120. Sliding the litter box region cover 110 may provide easier and more convenient access to these regions as compared to lowering the litter box region cover 110. Some embodiments may employ a hinge mechanism that allows the ramp 108 and/or the litter box region cover 110 to be lowered and to be slid sideways depending upon the preference of the pet owner.

In the various embodiments, grasping means 134 (FIGS. 1-7) may be provided to assist the pet owner to grasp the ramp 108 and/or the litter box region cover 110. The grasping means 134 may include finger holes, knobs, press and release knobs, pins, etc.

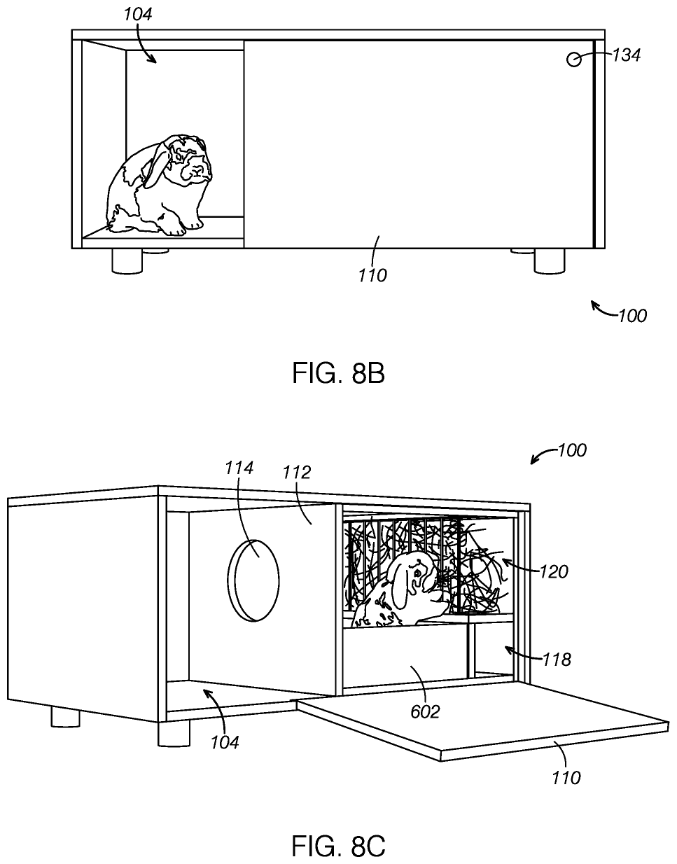

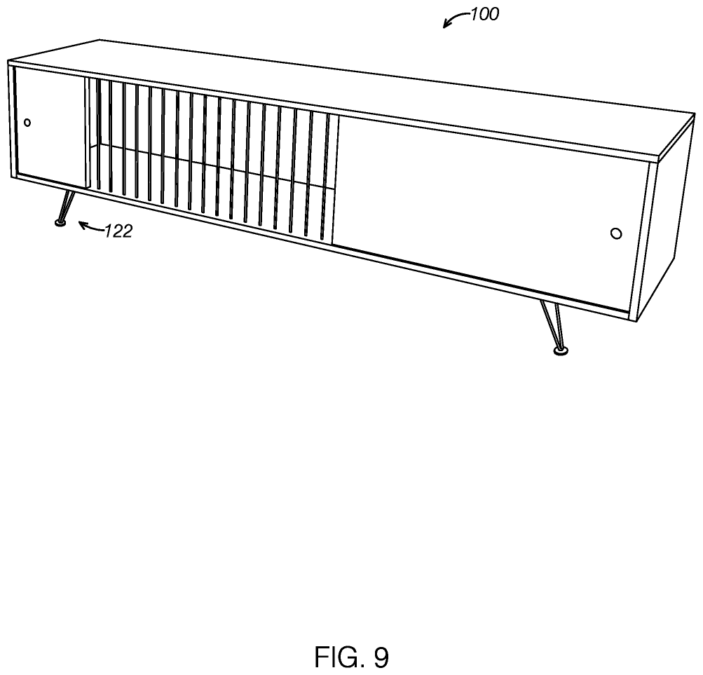

FIGS. 8A-8C are perspective views of an alternative embodiment of the integrated pet enclosure system 100. Here, the ramp 108 is omitted and the entrance interior region 104 is substantially smaller. Presumably, the entrance is low enough, or the pet 402 is agile enough, to be able to enter into the integrated pet enclosure system 100 without the aid of a ramp 108. Additionally, or alternatively, the height of the example embodiment may be adjusted such that the integrated pet enclosure system 100 functions as a bench.

In some embodiments, the entrance interior region 104 may be combined with the litter box interior region 106 by omitting the divider 112. Alternatively, the integrated pet enclosure system 100 size may be increased, and/or plurality of dividers 112 may be used to create multiple regions within the cabinet 102.

Embodiments of the integrated pet enclosure system 100, and components thereof, may be made of any suitable material. Suitable materials include, but are not limited to, wood, composite board, particle board, molded plastic, metal, etc.

FIG. 9 is an illustration of an embodiment of the integrated pet enclosure system 100 that is decorative so as to be suitable for use in a living room of the pet owner's home. Because the integrated pet enclosure system 100 may be fabricated from decorative materials, and/or painted in any desirable color, embodiments of the integrated pet enclosure system 100 may have a visually aesthetic appearance, and actually be considered as a piece of interior furniture that functions as a pet enclosure.

The embodiment of FIG. 9 is fabricated with the aesthetic appearance of a contemporary piece of furniture. The contemporary cabinet 102 integrates with the pet owner's interior design of the room where the integrated pet enclosure system 100 resides. One skilled in the art appreciates that any aesthetic design may be used to create a visually pleasing integrated pet enclosure system 100 that integrates with the décor chosen by the pet owner.

For example, the cabinet legs 122 illustrated in FIG. 1-6 are barrel shaped and lower cut to create an integrated pet enclosure system 100 that integrates into a particular décor. In FIG. 9, the cabinet legs 122 are long, angular, and slender, and terminate in a decorative brass pedestal, to emulate furniture legs of contemporary furniture.

It should be emphasized that the above-described embodiments of the integrated pet enclosure system 100 are merely possible examples of implementations of the invention. Many variations and modifications may be made to the above-described embodiments. All such modifications and variations are intended to be included herein within the scope of this disclosure and protected by any later filed claims.

Furthermore, the disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

1. An integrated pet enclosure system providing integrated food storage and supply storage regions, wherein the integrated pet enclosure system has a cabinet top, a cabinet bottom, a first cabinet end piece, a second cabinet end piece, and a back panel that all cooperatively define the integrated pet enclosure system, comprising:
an entrance interior region;
a litter box interior region; and
a divider between the entrance interior region and the litter box interior region, wherein the divider includes a hole to permit passage of a pet between the entrance interior region and the litter box interior region.

2. The integrated pet enclosure system of claim 1, wherein the litter box interior region is sized to receive a litter box used by a pet.

3. The integrated pet enclosure system of claim 1, further comprising:
a ramp that has a first edge that is hinge-connected to a bottom edge of the cabinet bottom,
wherein when the ramp is oriented vertically, an opening into the entrance interior region is closed, and
wherein when the ramp is oriented horizontally or is slanted downwardly, the opposing second edge of the ramp rests upon a floor that is supporting the integrated pet enclosure system so that the pet may enter or leave the entrance interior region.

4. The integrated pet enclosure system of claim 3, further comprising:
a plurality of non-slip adhesive treads secured to an interior surface of the ramp to provide traction to the pet that is entering or is leaving the integrated pet enclosure system.

5. The integrated pet enclosure system of claim 3, further comprising:
a barrier means that is set along and between a front edge of the cabinet top and a front edge of the cabinet bottom,
wherein the barrier means provide viewing by the pet into an area proximate to the integrated pet enclosure system, and facilitate air circulation within the entrance interior region, and
wherein the barrier means and the vertically oriented ramp define a closed entrance interior region such that the pet cannot exit the integrated pet enclosure system

6. The integrated pet enclosure system of claim 4, wherein the barrier means comprises:
a plurality of barrier dowels that are set along and between a front edge of the cabinet top and a front edge of the cabinet bottom,
wherein the plurality of barrier dowels provide viewing by the pet into an area proximate to the integrated pet enclosure system, and facilitate air circulation within the entrance interior region, and
wherein the plurality of barrier dowels and the vertically oriented ramp define a closed entrance interior region such that the pet cannot exit the integrated pet enclosure system.

7. The integrated pet enclosure system of claim 1, further comprising:
a sliding door that has a first edge that is rail that is slidably connected to a track disposed along a bottom edge of the cabinet bottom,
wherein when the sliding is slid into a first position, an opening into the entrance interior region is closed, and
wherein when the sliding door is slid into a second position, the pet may enter or leave the entrance interior region.

8. The integrated pet enclosure system of claim 7, further comprising:
a plurality of barrier dowels are set along and between a front edge of the cabinet top and a front edge the cabinet bottom,
wherein the plurality of barrier dowels provide viewing of the pet into an area proximate to the integrated pet enclosure system, and facilitate air circulation within the entrance interior region, and
wherein the plurality of barrier dowels and the vertically oriented ramp define a closed entrance interior region such that the pet cannot exit the integrated pet enclosure system.

9. The integrated pet enclosure system of claim 1, further comprising:
a litter box region cover that has a first edge that is hinge-connected to a bottom edge of the cabinet bottom,
wherein when the litter box region cover is oriented vertically, an opening into the litter box interior region is closed, and
wherein the litter box region cover is oriented horizontally or is slanted downwardly, the opposing second edge of the litter box region cover rests upon a floor that is supporting the integrated pet enclosure system so that a pet owner may access the litter box interior region.

10. The integrated pet enclosure system of claim 1, further comprising:
a litter box region cover that is rail that is slidably connected to a track disposed along a bottom edge of the cabinet bottom,
wherein when the litter box region cover is slid into a first position, an opening into the litter box interior region is closed, and
wherein when the litter box region cover is slid into a second position, a pet owner may access the litter box interior region.

11. The integrated pet enclosure system of claim 1, further comprising:
an inverted L-shaped member connected to the cabinet bottom at a first end and connected to the second cabinet end piece,
wherein the inverted L-shaped member has a length corresponding to a length of a bottom edge of the second cabinet end piece, and
wherein the inverted L-shaped member, a portion of the cabinet bottom, and a portion of the second cabinet end piece define a supply storage region within the litter box interior region that cannot be accessed by the pet.

12. The integrated pet enclosure system of claim 11, further comprising:
a plurality of vertically aligned food storage dowels disposed between a top surface of the inverted L-shaped member and a bottom surface of the cabinet top to define a food storage region within the litter box interior region,
wherein the plurality of food storage dowels cooperatively retain a food for the pet in the food storage region while allowing the pet to access the food.
